(19) United States
(12) Patent Application Publication
(10) Pub. No.: US 2016/0150301 A1
(43) Pub. Date: May 26, 2016

(54) PACKET TRANSFER SYSTEM, CONTROL DEVICE, CONTROL METHOD, AND NON-TRANSITORY COMPUTER-READABLE MEDIUM

(71) Applicant: NEC CORPORATION, Minato-ku, Tokyo (JP)

(72) Inventor: Masahiro HAYASHITANI, Tokyo (JP)

(21) Appl. No.: 14/904,173

(22) PCT Filed: Mar. 4, 2014
(86) PCT No.: PCT/JP2014/001167

§ 371 Date: Jan. 11, 2016

(30) Foreign Application Priority Data
Jul. 19, 2013 (JP) 2013-150611

(51) Int. Cl. H04Q 11/00; H04L 12/707; H04L 12/861

(52) U.S. Cl. CPC H04Q 11/0005; H04L 49/90; H04L 45/22; H04Q 2011/0039; H04Q 2011/0049

(57) ABSTRACT

A packet transfer system includes a packet transfer unit (1) that transfers a packet between a first route and a second route, an electric buffer (2) that electrically stores and transfers the packet between the packet transfer unit (1) and the second route, and a power control unit (3) that controls power of the electric buffer (2) in accordance with traffic flowing through the electric buffer (2). It is thereby possible to provide a packet transfer system, a control device, a control method, and a non-transitory computer-readable medium storing a control program capable of achieving lower energy consumption.

### TECHNICAL FIELD

The present invention relates to a packet transfer system, a control device, a control method, and a non-transitory computer-readable medium storing a control program and, particularly, to a packet transfer system that transfers packets, a control device, a control method, and a non-transitory computer-readable medium storing a control program.

### BACKGROUND ART

With a recent rapid increase in traffic on a network, an increase in power consumption of a network has become an issue. In order to prevent an increase in power consumption of a network, development of photonic network technology is being done. Because the photonic network technology processes data by optical processing, lower energy consumption can be achieved. However, the implementation of an optical buffer (memory) is technically difficult in the photonic network, and the use of an electric buffer at a node (network node) is typical in the existing state of technology.

Patent Literatures 1 to 5, for example, are known as related art. According to the technique disclosed in Patent Literature 1, a part of a module that forms ONU is set to power saving mode. According to the technique disclosed in Patent Literature 2, the power of a WDM module is turned off. According to the technique disclosed in Patent Literature 3, each node that constitutes an optical network monitors traffic. According to the technique disclosed in Patent Literature 4, all traffic on a network is aggregated into a specified node. According to the technique disclosed in Patent Literature 5, a top-of-rack switch that aggregates traffic of a plurality of physical servers is described.

### CITATION LIST

### Patent Literature

PTL1: Japanese Unexamined Patent Publication No. 2012-095089

PTL2: Japanese Unexamined Patent Publication No. 2007-306316

PTL3: Japanese Unexamined Patent Publication No. 2006-166343

PTL4: Japanese Unexamined Patent Publication No. 2012-169823

PTL5: Japanese Unexamined Patent Publication No. 2013-026816

### SUMMARY OF INVENTION

### Technical Problem

In Patent Literatures 1 to 5, no consideration is made to a node that constitutes the above-described photonic network, and therefore it is not possible to achieve lower energy consumption depending on the configuration of the node.

Further, an electric buffer is used at a node that constitutes the photonic network as described above. Therefore, it is difficult to achieve lower energy consumption depending on the power consumption of the electric buffer.

In light of the above, an exemplary object of the present invention is to provide a packet transfer system, a control device, a control method, and a non-transitory computer-readable medium storing a control program capable of achieving lower energy consumption.

### Solution to Problem

A packet transfer system according to an exemplary aspect of the present invention includes a packet transfer unit that transfers a packet between a first route and a second route, an electric buffer that electrically stores and transfers the packet between the packet transfer means and the second route, and a power control unit that controls power of the electric buffer according to traffic flowing through the electric buffer.

A control device according to an exemplary aspect of the present invention includes a traffic detection unit that detects traffic flowing through an electric buffer included in a node constituting a network, the electric buffer electrically storing a packet transferred by the node, and a power control unit that controls power of the electric buffer according to the detected traffic.

A control method according to an exemplary aspect of the present invention includes detecting traffic flowing through an electric buffer included in a node constituting a network, the electric buffer electrically storing a packet transferred by the node, and controlling power of the electric buffer according to the detected traffic.

A non-transitory computer-readable medium storing a control program according to an exemplary aspect of the present invention is a non-transitory computer-readable medium storing a control program causing a computer to perform a control process including detecting traffic flowing through an electric buffer included in a node constituting a network, the electric buffer electrically storing a packet transferred by the node, and controlling power of the electric buffer according to the detected traffic.

### Advantageous Effects of Invention

According to the exemplary aspects of the present invention, it is possible to provide a packet transfer system, a control device, a control method, and a non-transitory computer-readable medium storing a control program capable of achieving lower energy consumption.

### BRIEF DESCRIPTION OF DRAWINGS

FIG. 1 is a diagram showing a schematic configuration of a packet transfer system according to a first exemplary embodiment;

FIG. 2 is a diagram showing a schematic configuration of a control device according to the first exemplary embodiment;

FIG. 3 is a diagram showing a configuration example of a network system according to the first exemplary embodiment;

FIG. 4 is a diagram showing a configuration example of a node control device and a node according to the first exemplary embodiment;

FIG. 5 is a flowchart showing an operation example of the node control device according to the first exemplary embodiment;

FIG. 6 is a diagram showing a schematic configuration of a network system according to a second exemplary embodiment;

FIG. 7 is a diagram showing a configuration example of a node control device and a node according to the second exemplary embodiment;

FIG. 8 is a flowchart showing an operation example of the node control device according to the second exemplary embodiment;

FIG. 9 is an explanatory diagram illustrating route aggregation according to the second exemplary embodiment;

FIG. 10 is an explanatory diagram illustrating route aggregation according to the second exemplary embodiment;

FIG. 11 is a diagram showing a schematic configuration of a network system according to a third exemplary embodiment;

FIG. 12 is a diagram showing a configuration example of a node control device and a node according to the third exemplary embodiment;

FIG. 13 is a flowchart showing an operation example of the node control device according to the third exemplary embodiment;

FIG. 14 is an explanatory diagram illustrating server function integration according to the third exemplary embodiment;

FIG. 15 is an explanatory diagram illustrating server function integration according to the third exemplary embodiment;

### DESCRIPTION OF EMBODIMENTS

### First Exemplary Embodiment

A first exemplary embodiment is described hereinafter with reference to the drawings.

### Overview of First Exemplary Embodiment

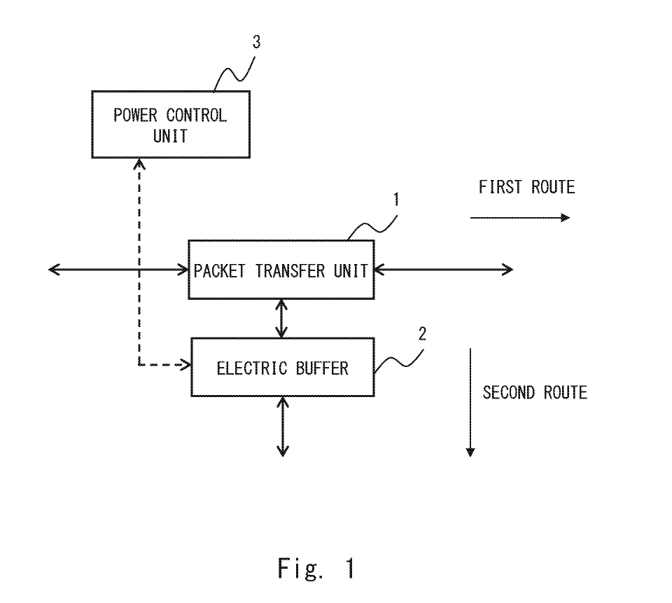

The overview of the characteristics of the first exemplary embodiment is described first. FIG. 1 shows one example of main elements of a packet transfer system according to this exemplary embodiment.

As shown in FIG. 1, the packet transfer system according to this exemplary embodiment includes a packet transfer unit 1, an electric buffer 2, and a power control unit 3. The packet transfer unit 1 transfers a packet between a first route and a second route. The electric buffer 2 electrically stores and transfers a packet between the packet transfer unit 1 and the second route (or on the second route). The power control unit 3 controls the power of the electric buffer 2 according to traffic flowing through the electric buffer 2.

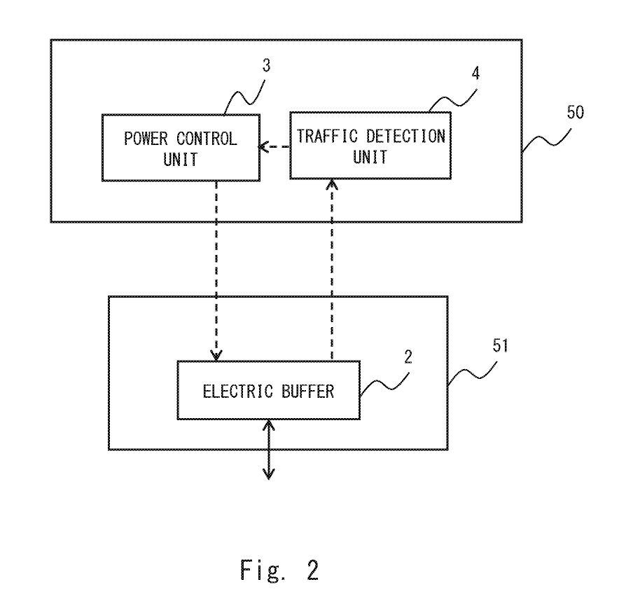

FIG. 2 shows another example of main elements of a control device according to this exemplary embodiment. As shown in FIG. 2, a control device 50 according to this exemplary embodiment controls a node 51 that constitutes a network, and it includes a traffic detection unit 4 and a power control unit 3. The traffic detection unit 4 detects traffic flowing through the electric buffer 2 that is included in the node 51 and that electrically stores packets transferred by the node 51. The power control unit 3 controls the power of the electric buffer 2 according to the detected traffic.

As described above, in this exemplary embodiment, the power of the electric buffer is controlled according to traffic flowing through the electric buffer. For example, when there is no traffic flowing through the electric buffer, the electric buffer can be powered off. It is thus possible to lower the power consumption of the electric buffer according to traffic and thereby achieve lower energy consumption.

### Configuration of First Exemplary Embodiment

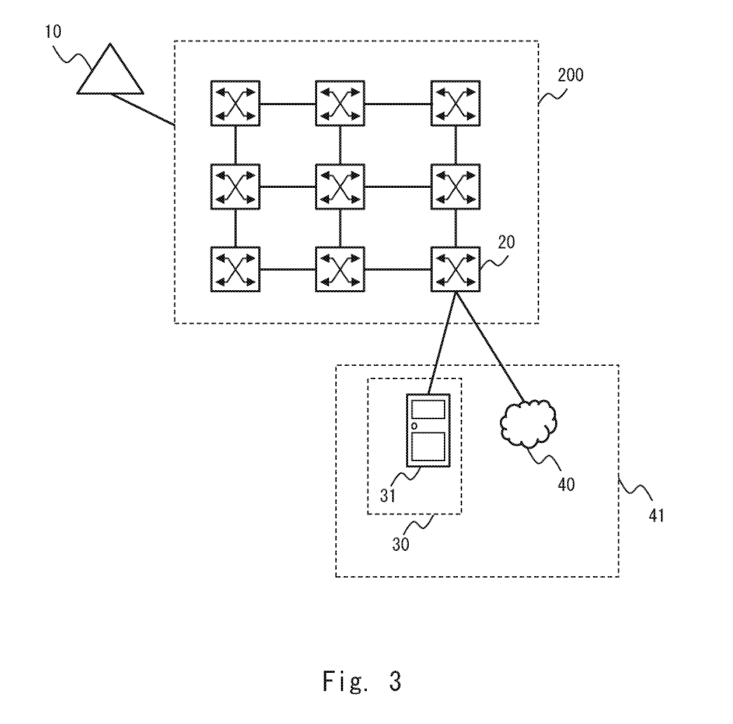

A configuration example of the first exemplary embodiment is described hereinafter. FIG. 3 shows a configuration example of a network system according to this exemplary embodiment.

As shown in FIG. 3, the network system according to this exemplary embodiment includes a plurality of nodes 20 that constitute a network 200 and a node control device 10 that controls the plurality of nodes 20.

In this example, the network 200 is a lattice network in which a plurality of nodes 20 are arranged in a lattice (matrix). Although nine nodes 20 are shown in FIG. 3, any number of nodes 20 may be included. Further, the network 200 may be configured in another topology such as a ring, mesh or tree topology.

The network 200 is a photonic network (or an optical network) as one example, in which adjacent nodes 20 are connected to be able to communicate with each other through a connection line such as an optical fiber. Note that the network 200 is not limited to a photonic network (or an optical network), and it may be another wired/wireless network. The node control device 10 is connected to be able to communicate with each of the plurality of nodes 20 in order to control them. Note that, in this exemplary embodiment, the node control device 10 may be connected to be able to communicate with one node 20 in order to control one node 20.

The node 20 transfers a packet to another node 20 that constitutes the network 200, which is, in the network 200, and also transfers a packet to a connection system 41 other than the node 20. The connection system 41 that is connected with the node 20 includes an arbitrary device and system such as a server group 30 and an external network 40. For example, the node 20 is connected with (accommodates) the server group 30 that includes a plurality of servers 31 under its control, and transfers a packet with the server group 30. Note that the network 200 may include the plurality of nodes 20 and the serve group 30. Further, for example, the node 20 is connected with the external network 40 that is outside the network (internal network) 200 and transfers a packet with the external network 40.

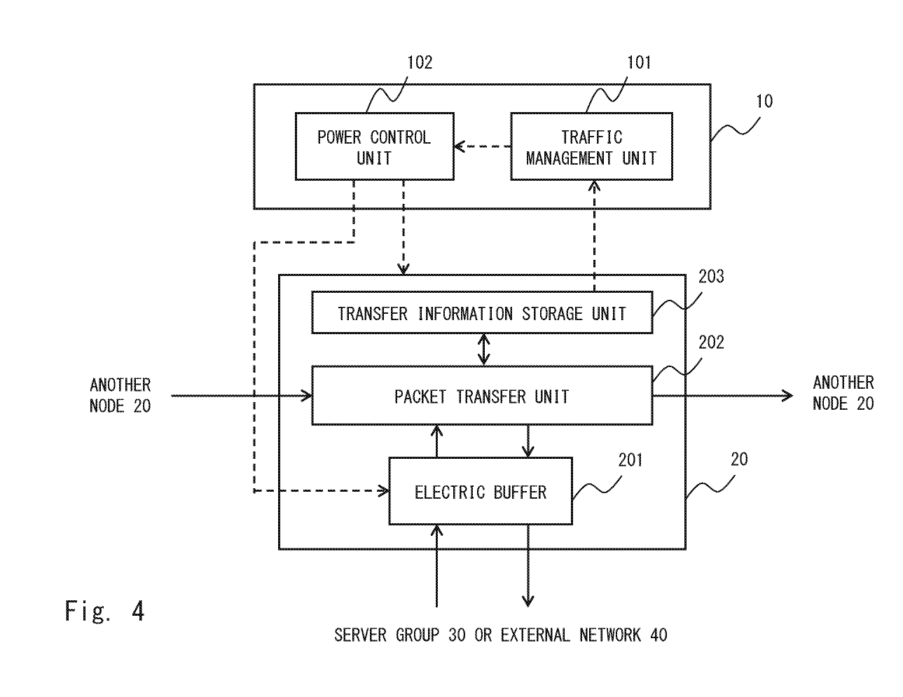

FIG. 4 shows a configuration example of the node control device 10 and the node 20 according to the first exemplary embodiment. FIG. 4 shows the node control device 10 and one node 20 included in the network system shown in FIG. 3. Although the node control device 10 is an external device of the node 20 in the following description, it is not limited thereto, and the node control device 10 may be included in the node 20.

As shown in FIG. 4, the node 20 includes an electric buffer 201, a packet transfer unit 202, and a transfer information storage unit 203. For example, a route between the node 20 and another node 20 (inside the network 200) is a first route, and a route between the node 20 and the server group 30 or the external network 40 is a second route. Note that the node 20 includes a power supply unit that supplies power to the whole node 20 including the respective elements (the electric buffer 201, the packet transfer unit 202 and the transfer information storage unit 203), and can switch on/off of power supply from the power supply unit to each element (power on/off of each element) and on/off of power supply from the power supply unit to the whole node 20 (power on/off of the whole node 20) according to control by the node control device 10.

The transfer information storage unit 203 stores transfer information (transfer destination information, transfer table) of packets and it can be referred to from the packet transfer unit 202. Further, the transfer information storage unit 203 transmits the transfer information stored in the transfer information storage unit 203 to the node control device 10.

The transfer information is information for the packet transfer unit 202 to transfer a packet, and it may be prestored in the transfer information storage unit 203 or may be stored in response to an instruction from the node control device 10. For example, the node 20 generates the transfer information according to a received packet. Traffic flowing through the node 20 can be thereby determined based on the transfer information. For example, when the transfer information corresponding to the received packet is not stored in the transfer information storage unit 203, the node 20, or the node control device 10 in response to an inquiry from the node 20, may generate the transfer information. The node 20 or the node control device 10 may generate the transfer information based on policy information that specifies a network policy or the like.

For example, the transfer information associates transmission destination (transfer destination) information with each destination information (destination address or label) of a packet. The transmission destination information may contain information that identifies a route, link, line, label or the like. The transfer information is, in other words, a transfer rule (flow table) for transferring a packet. Specifically, the transfer information may contain a flow entry that describes conditions and processing (action) of a flow to which a packet belongs. For example, by referring to the destination information or flow conditions contained in the transfer information, it is possible to determine the presence or absence of traffic addressed to the server group 30 or the external network 40 (traffic flowing through the electric buffer 201) or the presence or absence of traffic addressed to another node 20 (to the network 200) (traffic flowing through the packet transfer unit 202).

The packet transfer unit 202 receives a packet from another node 20, determines the transmission destination corresponding to the destination information or the like of the packet based on the transfer information in the transfer information storage unit 203, and transmits the packet to the determined destination. For example, when the transmission destination is the network 200 composed of the nodes 20, the packet transfer unit 202 transmits the packet to another node 20, and when the transmission destination is other than that, the packet transfer unit 202 transmits the packet to the server group 30 or the external network 40 through the electric buffer 201.

The electric buffer 201 electrically stores and outputs (transfers) the input data (packet). The electric buffer 201 transmits the data (packet) that is input from another node 20 through the packet transfer unit 202 to the server group 30 or the external network 40 under the node 20. Further, the electric buffer 201 transmits the data (packet) that is input from the server group 30 or the external network 40 to another node 20 through the packet transfer unit 202.

For example, the node 20 is an optical transmission device such as an optical packet router. It is thereby possible to achieve lower energy consumption in a photonic network (or optical network). In the optical transmission device, the packet transfer unit 202 can be an optical switch that switches an optical packet (an optical signal corresponding to a packet). Further, the electric buffer 201 can be a memory such as RAM (Random Access Memory) that stores an electric signal corresponding to a packet (converted from an optical packet). Note that the node 20 is not limited to an optical transmission device and may be another transmission device.

The node control device 10 controls the transfer (transfer information) of the node 20 and further controls the power supply of the node 20. Although the power-off control of the node 20 or the electric buffer 201 is described hereinafter, the power-on control may be performed according to need. For example, after the node 20 or the electric buffer 201 is powered off, the node 20 or the electric buffer 201 may be powered on after a certain period of time.

As shown in FIG. 4, the node control device 10 includes a traffic management unit 101 and a power control unit 102. The traffic management unit (traffic detection unit) 101 receives the transfer information stored in the transfer information storage unit 203 from the node 20 and grasps (detects) the traffic status in the node 20 based on the received transfer information. Traffic information that indicates the traffic status grasped by the traffic management unit 101 is received by the power control unit 102.

The power control unit 102 performs the power-off control of the electric buffer 201 in the node 20 or the power-off control of the whole node 20 based on the traffic information received from the traffic management unit 101. Stated differently, the power control unit 102 receives the transfer information from the transfer information storage unit 203 through the traffic management unit 101 and performs the power-off control of the electric buffer 201 or the whole node 20 based on the received transfer information. For example, the power control unit 102 may include a traffic detection unit that detects traffic flowing through the node 20.

### Operation of First Exemplary Embodiment

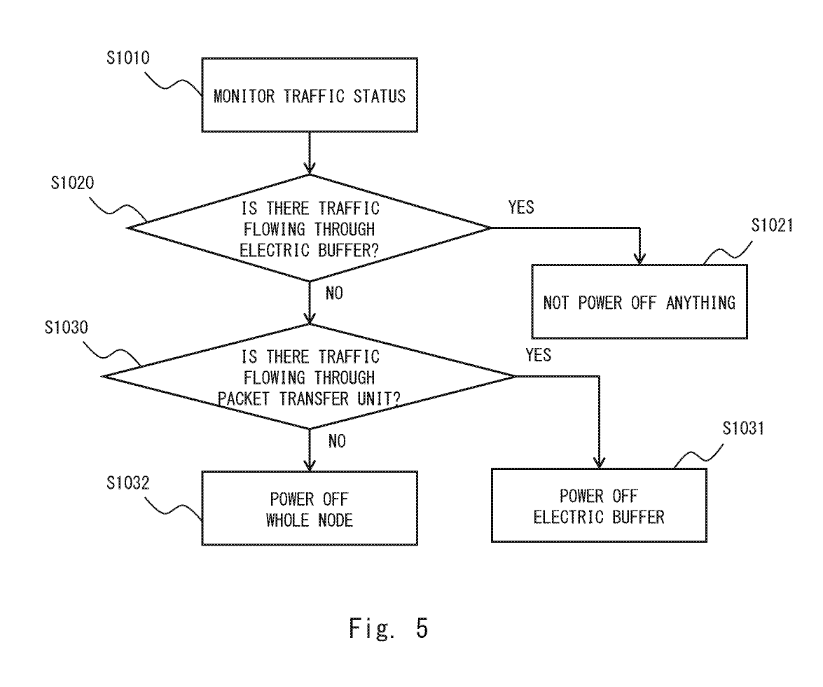

An operation example of the first exemplary embodiment is described hereinafter. FIG. 5 is a flowchart showing an operation of the node control device 10 according to the first exemplary embodiment.

First, the traffic management unit 101 of the node control device 10 monitors the traffic status (S110). The traffic management unit 101 receives the transfer information in the transfer information storage unit 203 from the node 20 and grasps the traffic status of the node 20 by the received transfer information. It is assumed that the transfer information stored in the transfer information storage unit 203 is in conjunction with the transmission state of traffic on the node 20. For example, the traffic management unit 101 may receive the transfer information from the node 20 at regular intervals. The traffic management unit 101 transmits the traffic information (transfer information) indicating the grasped traffic status to the power control unit 102.

Next, the power control unit 102 of the node control device 10 checks whether there is traffic flowing through the electric buffer 201 (S1020). The checking of traffic in S1020 is done based on whether the transfer information addressed to the server group 30 or the external network 40 is contained in the transfer information stored in the transfer information storage unit 203. The power control unit 102 receives the transfer information (traffic information) from the traffic management unit 101 and, when the transfer information addressed to the server group 30 or the external network 40 is contained in the received transfer information, the power control unit 102 determines that there is traffic flowing through the electric buffer 201, and when the transfer information addressed to the server group 30 or the external network 40 is not contained in the received transfer information, the power control unit 102 determines that there is no traffic flowing through the electric buffer 201.

When there is traffic flowing through the electric buffer 201 (Yes in S1020), the power control unit 102 of the node control device 10 does not perform the power-off control related to the node (S1021). In this case, the power control unit 102 does not perform the power-off control of the electric buffer 201 and the power-off control of the whole node 20 so as to enable the transfer of a packet addressed to the server group 30 or the external network 40.

When, on the other hand, there is no traffic flowing through the electric buffer 201 (No in S1020), the power control unit 102 of the node control device 10 checks whether there is traffic flowing through the packet transfer unit 202 (S1030). The checking of traffic in S1030 is done based on whether the transfer information is stored in the transfer information storage unit 203. When the transfer information is stored in the transfer information storage unit 203, which is, when the transfer information (traffic information) is received from the traffic management unit 101 (when the transfer information is contained in the traffic information), the power control unit 102 determines that there is traffic flowing through the packet transfer unit 202 (traffic addressed to the network 200 or another mode 20), and when the transfer information is not stored in the transfer information storage unit 203, which is, when the transfer information (traffic information) is not received from the traffic management unit 101 (when the transfer information is not contained in the traffic information), the power control unit 102 determines that there is no traffic flowing through the packet transfer unit 202.

When there is traffic flowing through the packet transfer unit 202 (Yes in S1030), the power control unit 102 of the node control device 10 controls to power off the electric buffer 201 in the node 20 (S1031). In this case, because the transfer of a packet addressed to the server group 30 or the external network 40 is not necessary, and, in order to enable the transfer of a packet addressed to another node 20 only, the power control unit 102 performs the power-off control of the electric buffer 201 without performing the power-off control of the whole node 20. Note that the power control unit 102 may perform the power-off control of the electric buffer 201 at all times when there is no traffic flowing through the electric buffer 201. For example, the power-off control of the electric buffer 201 may be performed when there is no traffic flowing through the electric buffer 201 (S1031), and the power-off control of the whole node 20 may be further performed when there is no traffic flowing through the packet transfer unit 202 (S1032).

When, on the other hand, there is no traffic flowing through the packet transfer unit 202 (No in S1030), the power control unit 102 of the node control device 10 controls to power off the whole node 20 (S1032). In this case, because the transfer of a packet addressed to the server group 30 or the external network 40 is not necessary, and the transfer of a packet addressed to another node 20 is also not necessary, the power control unit 102 performs the power-off control of the whole node 20.

### Effects of First Exemplary Embodiment

Effects of this exemplary embodiment are described hereinbelow. In this exemplary embodiment, the power of the whole node or the power of the electric buffer in the node is controlled according to traffic on the node, and it is thus possible to achieve lower energy consumption of the network.

Specifically, in the related art and the like, because an electric buffer is used in a node in an optical network or the like, there is a concern about power consumption at an increase in traffic. In this exemplary embodiment, the whole node is powered off or the electric buffer is powered off according to the presence or absence of traffic flowing through the electric buffer and the presence or absence of traffic flowing through the packet transfer unit. It is thereby possible to achieve lower energy consumption of the network without affecting traffic. Because the power consumption of the electric buffer in the node is dominant in the optical network, the power consumption can be effectively reduced by powering off the electric buffer. Further, in the optical network, even when the electric buffer is powered off, data can be transmitted between the nodes unless collision of packets occurs, and therefore the effect on the network can be reduced.

### Second Exemplary Embodiment

A second exemplary embodiment is described hereinafter with reference to the drawings. In the second exemplary embodiment, energy consumption is further reduced by route aggregation in the node control device.

### Overview of Second Exemplary Embodiment

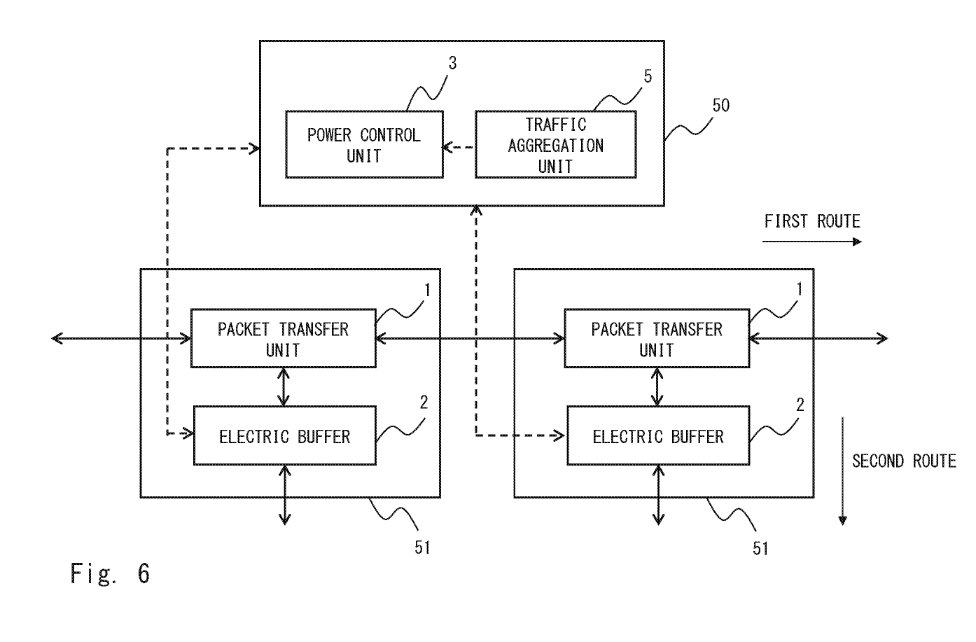

The overview of the characteristics of the second exemplary embodiment is described first. FIG. 6 shows one example of main elements of a network system according to this exemplary embodiment.

As shown in FIG. 6, the network system according to this exemplary embodiment includes a plurality of nodes 51 that constitute a network and a control device 50 that controls the plurality of nodes 51. Each of the plurality of nodes 51 includes a packet transfer unit 1 and an electric buffer 2. The packet transfer unit 1 transfers a packet between a first route (a route between the nodes 51) and a second route (a route with a part different from the node 51). The electric buffer 2 electrically stores and transfers a packet between the packet transfer unit 1 and the second route.

The control device 50 includes a traffic aggregation unit 5 and a power control unit 3. The traffic aggregation unit 5 aggregates the routes of traffic going through the plurality of nodes 51 according to traffic flowing through the network. The power control unit 3 selects and controls any one of the power of the electric buffer 2 and the power of the whole node 51 according to the aggregate traffic route.

In this manner, in this exemplary embodiment, the traffic of a plurality of nodes is aggregated, and the power of the electric buffer or the whole node is controlled according to the aggregate traffic. By aggregation of traffic, the electric buffer or the node whose power can be controlled increases, and it is thereby possible to achieve further reduction of energy consumption.

### Configuration of Second Exemplary Embodiment

A configuration example of the second exemplary embodiment is described hereinafter. The configuration of the network system according to this exemplary embodiment is the same as that of the first exemplary embodiment shown in FIG. 3. The network system according to this exemplary embodiment includes a plurality of nodes (which are referred to as nodes 21 in this exemplary embodiment) that constitute a network 200 and a node control device (which is referred to as a node control device 11 in this exemplary embodiment) that controls the plurality of nodes 21. Further, a connection system 41 such as a server group 30 or an external network 40 is connected to the plurality of nodes 21.

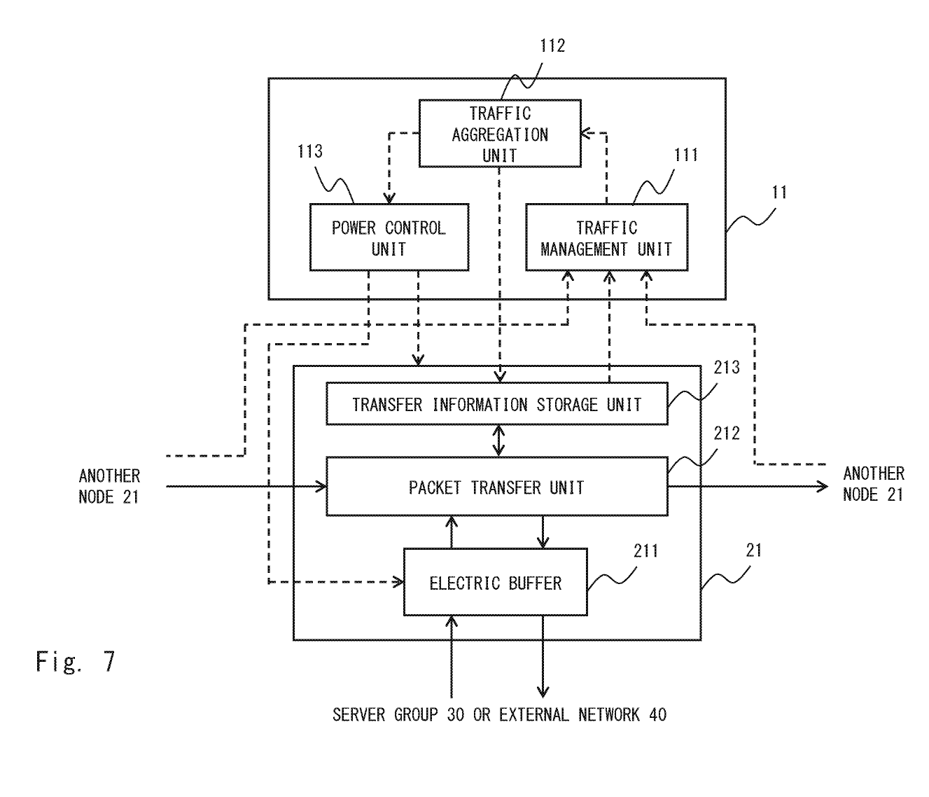

FIG. 7 shows a configuration example of the node control device 11 and the node 21 according to the second exemplary embodiment. FIG. 7 shows the node control device 11 and one node 21 included in the network system such as the one shown in FIG. 3. It is assumed that the node control device 11 is an external device of the node 21 and receives transfer information from a transfer information storage unit 213 of the plurality of nodes 21.

As shown in FIG. 7, the node 21 includes an electric buffer 211, a packet transfer unit 212 and a transfer information storage unit 213. The node 21 according to this exemplary embodiment has the same configuration as the node 20 according to the first exemplary embodiment, and it is an optical transmission device such as an optical packet router, for example.

Specifically, the transfer information storage unit 213 stores transfer information (transfer destination information, transfer table) of packets and it is referred to from the packet transfer unit 212. Further, the transfer information storage unit 213 transmits the transfer information stored in the transfer information storage unit 213 to the node control device 11.

The packet transfer unit 212 receives a packet from another node 20, determines the transmission destination corresponding to the destination information or the like of the packet based on the transfer information in the transfer information storage unit 213, and transmits the packet to the determined destination. For example, when the transmission destination is the network 200 composed of the nodes 21, the packet transfer unit 212 transmits the packet to another node 21, and when the transmission destination is other than that, the packet transfer unit 212 transmits the packet to the server group 30 or the external network 40 through the electric buffer 211.

The electric buffer 211 transmits the data (packet) that is input from another node 21 through the packet transfer unit 212 to the server group 30 or the external network 40 under the node 21. Further, the electric buffer 211 transmits the data (packet) that is input from the server group 30 or the external network 40 to another node 21 through the packet transfer unit 212.

The node control device 11 according to this exemplary embodiment includes a traffic aggregation unit in addition to the elements of the node control device 11 according to the first exemplary embodiment. Specifically, as shown in FIG. 7, the node control device 11 includes a traffic management unit 111, a traffic aggregation unit 112, and a power control unit 113.

The traffic management unit 111 receives the transfer information stored in the transfer information storage unit 213 from each node 21 and grasps (detects) the traffic status in the network 200 based on the received transfer information. Traffic information that indicates the traffic status grasped by the traffic management unit 111 is received by the traffic aggregation unit 112.

The traffic aggregation unit 112 performs aggregation of traffic based on the traffic information received from the traffic management unit 111. Further, the traffic aggregation unit 112 transmits traffic aggregation information (route aggregation information) indicating a result of traffic aggregation to the power control unit 113. The power control unit 113 performs the power-off control of the electric buffer 211 in the node 21 or the power-off control of the whole node 21 based on the traffic aggregation information received from the traffic aggregation unit 112.

### Operation of Second Exemplary Embodiment

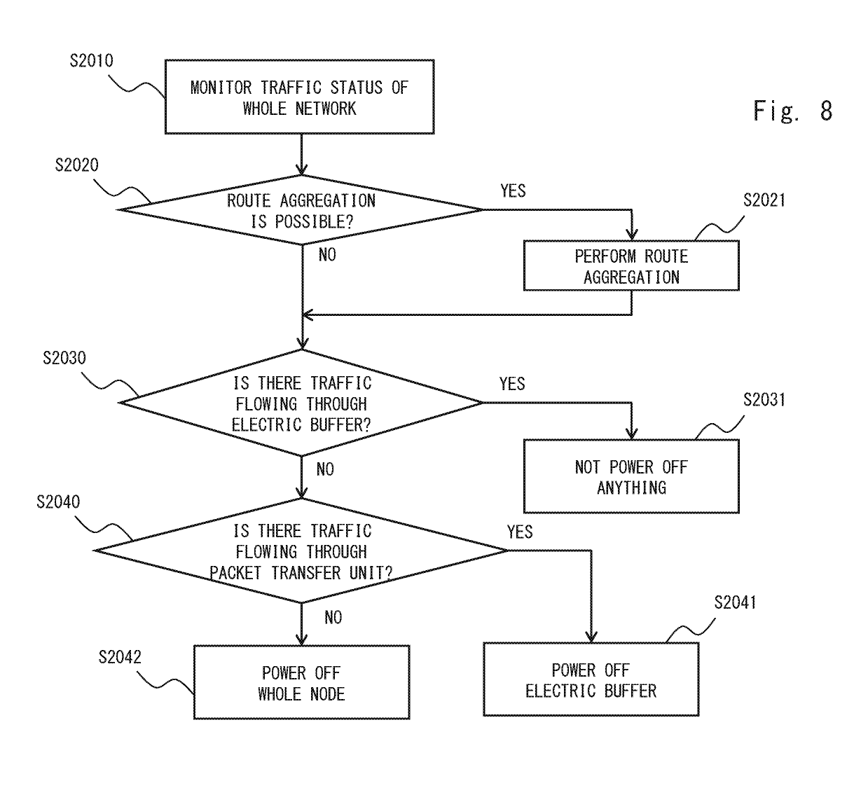

An operation example of the second exemplary embodiment is described hereinafter. FIG. 8 is a flowchart showing an operation of the node control device 11 according to the second exemplary embodiment.

First, the traffic management unit 111 of the node control device 11 monitors the traffic status of the whole network 200 (S2010). The traffic management unit 111 receives the transfer information in the transfer information storage unit 213 from each node 21 and grasps the traffic status of the whole network 200 by the received transfer information. The traffic management unit 111 transmits the traffic information (transfer information) indicating the grasped traffic status to the traffic aggregation unit 112.

Next, the traffic aggregation unit 112 of the node control device 11 checks whether route aggregation of traffic is possible or not from the traffic status of the whole network 200 (S2020). The traffic aggregation unit 112 specifies the route of traffic based on the traffic information received from the traffic management unit 111 and determines whether aggregation of the specified traffic route is possible or not. For example, the traffic aggregation unit 112 determines whether it is possible to perform route aggregation so as to eliminate the traffic of a given node 21. Further, the traffic aggregation unit 112 determines whether it is possible to perform route aggregation while maintaining the route length or maintaining the shortest route. The traffic aggregation unit 112 may determine whether route aggregation is possible based on the transmission band of the node 21.

When traffic route aggregation is possible (Yes in S2020), the traffic aggregation unit 112 of the node control device 11 performs route aggregation of traffic (S2021). The traffic aggregation unit 112 aggregates the route of traffic so as to eliminate the traffic of a given node 21. As a result, it becomes possible to power off the whole node 21 with no traffic. Further, the traffic aggregation unit 112 aggregates the route of traffic so as to maintain the route length or maintain the shortest route. Because the route length does not increase after route aggregation, traffic transmission is not affected. After performing route aggregation, the traffic aggregation unit 112 updates the transfer information of the transfer information storage unit 213 in each node so that the aggregate route is formed, and transmits route aggregation information (updated transfer information after route aggregation) indicating the aggregate route to the power control unit 113.

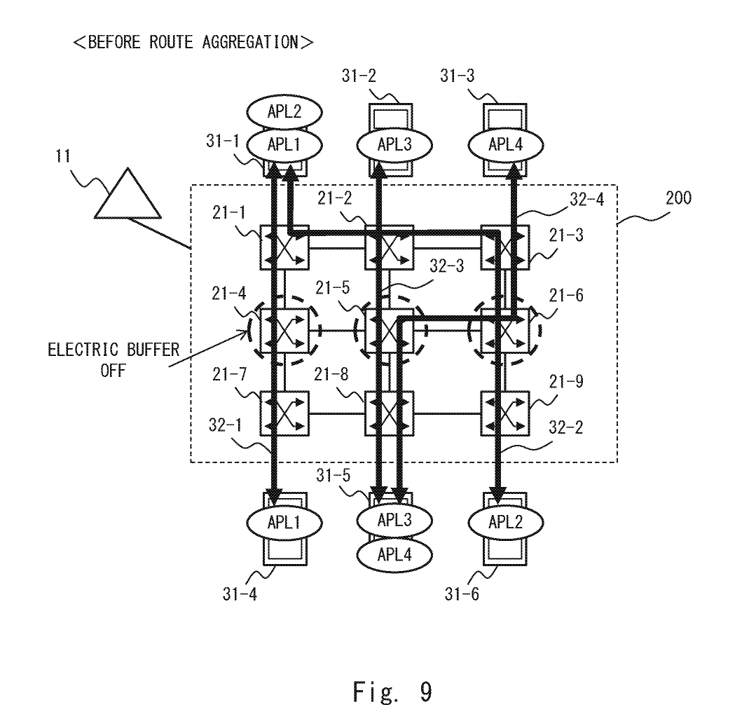

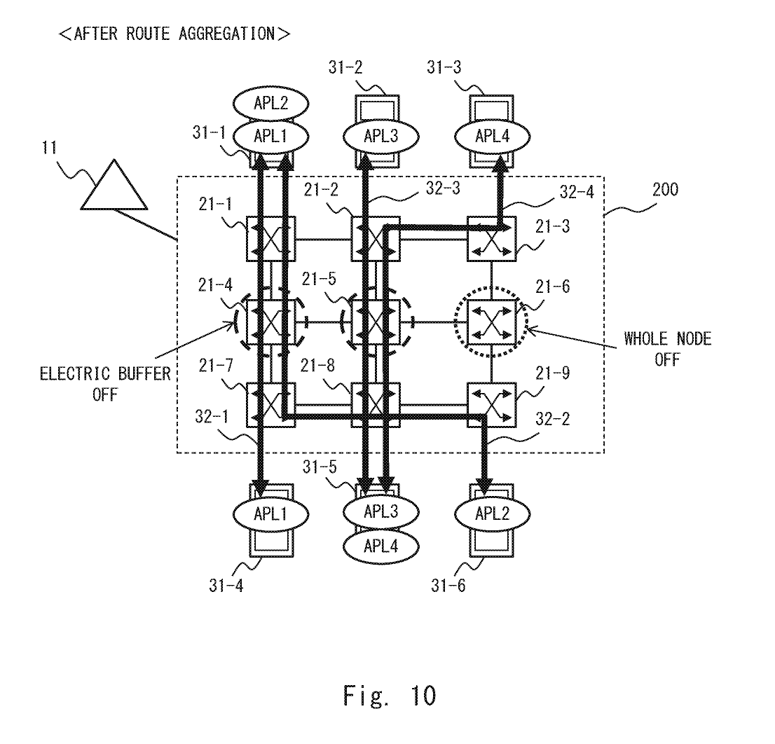

FIGS. 9 and 10 show an example of route aggregation performed in S2021. FIGS. 9 and 10 show the case where packets are transmitted between applications of servers 31 through the network 200 that includes nodes 21-1 to 21-9. FIG. 9 shows the state before traffic route aggregation, and FIG. 10 shows the state after traffic route aggregation. In FIGS. 9 and 10, servers 31-1 to 31-3 are respectively connected to the nodes 21-1 to 21-3, and servers 31-4 to 31-6 are respectively connected to the nodes 21-7 to 21-9.

In the state before traffic route aggregation shown in FIG. 9, an application APL1 of the server 31-1 and an application APL1 of the server 31-4 transmit and receive a packet through a route 32-1 that goes through the nodes 21-1, 21-4 and 21-7. An application APL2 of the server 31-1 and an application APL2 of the server 31-6 transmit and receive a packet through a route 32-2 that goes through the nodes 21-1, 21-2, 21-3, 21-6 and 21-9. An application APL3 of the server 31-2 and an application APL3 of the server 31-5 transmit and receive a packet through a route 32-3 that goes through the nodes 21-2, 21-5 and 21-8. An application APL4 of the server 31-3 and an application APL4 of the server 31-5 transmit and receive a packet through a route 32-4 that goes through the nodes 21-3, 21-6, 21-5 and 21-8. In FIG. 9, because the nodes 21-4 to 21-6 are not connected to the server 31 or the like, there is no traffic flowing through the electric buffer 211, and therefore the power-off control of the electric buffer 211 is possible.

The traffic aggregation unit 112 aggregates the routes of traffic shown in FIG. 9 into the routes shown in FIG. 10. To be specific, as shown in FIG. 10, the traffic aggregation unit 112 switches the route 32-2 of the application APL2 into a route that goes through the nodes 21-1, 21-4, 21-7, 21-8 and 21-9, and switches the route 32-4 of the application APL4 into a route that goes through the nodes 21-3, 21-2, 21-5 and 21-8. Specifically, the traffic aggregation unit 112 aggregates the routes so that the route 32-1 of the application APL1 and the route 32-2 of the application APL2 go through the node 21-4, and the route 32-3 of the application APL3 and the route 32-4 of the application APL4 go through the node 21-5. The traffic aggregation unit 112 thereby aggregates the routes to eliminate the traffic on the node 21-6 and also to maintain the route length (shortest route) of the routes 32-2 and 32-4 to be switched.

By switching and aggregating the routes of the application APL2 and the application APL4 as shown in FIG. 10, traffic flowing through the node 21-6 can be eliminated, and it becomes possible to control to power off the whole one node 21-6. Further, in the same manner as in FIG. 9, it is possible to control to power off the electric buffer 211 of the nodes 21-4 and 21-5.

In FIG. 8, after traffic route aggregation (S2021) or when traffic route aggregation cannot be performed (No in S2020), the power control unit 113 of the node control device 11 checks whether there is traffic flowing through the electric buffer 211 of each node 21 (S2030). The checking of traffic in S2030 is done based on whether the transfer information addressed to the server group 30 or the external network 40 from each node 21 is contained in the transfer information (route aggregation information) received from the traffic aggregation unit 112. The power control unit 113 receives the transfer information from the traffic aggregation unit 112 and, when the transfer information addressed to the server group 30 or the external network 40 from the node 21 is contained in the received transfer information, the power control unit 113 determines that there is traffic flowing through the electric buffer 211 of the corresponding node 21, and when the transfer information addressed to the server group 30 or the external network 40 from the node 21 is not contained in the received transfer information, the power control unit 113 determines that there is no traffic flowing through the electric buffer 211 of the corresponding node 21.

When there is traffic flowing through the electric buffer 211 (Yes in S2030), the power control unit 113 of the node control device 11 does not perform the power-off control related to the node on the corresponding node 21 (S2031). The power control unit 113 determines the presence or absence of traffic on the electric buffer 211 for all nodes 21, and for the node 21 where there is traffic flowing through the electric buffer 211, the power control unit 113 does not perform the power-off control of the electric buffer 211 and the power-off control of the whole node 21 so as to enable the transfer of a packet addressed to the server group 30 or the external network 40.

When, on the other hand, there is no traffic flowing through the electric buffer 211 (No in S2030), the power control unit 113 of the node control device 11 checks whether there is traffic flowing through the packet transfer unit 212 of each node 21 (S2040). The checking of traffic in S2040 is done based on whether the transfer information of the node 21 is contained in the transfer information received from the traffic aggregation unit 112, that is, whether the transfer information is stored in the transfer information storage unit 213 of the node 21. When the transfer information of the node 21 is received from the traffic aggregation unit 112 (when the transfer information of the node 21 is contained in the route aggregation information), that is, when the transfer information is stored in the transfer information storage unit 213 of the node 21, the power control unit 113 determines that there is traffic flowing through the packet transfer unit 212 of the corresponding node 21, and when the transfer information of the node 21 is not received from the traffic aggregation unit 112 (when the transfer information of the node 21 is not contained in the route aggregation information), that is, when the transfer information is not stored in the transfer information storage unit 213 of the node 21, the power control unit 113 determines that there is no traffic flowing through the packet transfer unit 212 of the corresponding node 21.

When there is traffic flowing through the packet transfer unit 212 (Yes in S2040), the power control unit 113 of the node control device 11 controls to power off the electric buffer 211 in the corresponding node 21 (S2041). The power control unit 113 determines the presence or absence of traffic on the packet transfer unit 212 for all of the nodes 21 where it is determined that there is traffic flowing through the electric buffer 211, and for the node 21 where there is traffic flowing through the packet transfer unit 212, the power control unit 113 does not perform the power-off control of the whole node 21 and performs the power-off control of the electric buffer 211 so as to enable the transfer of a packet addressed to another node 21 only. For example, in FIG. 10, the power control unit 113 performs the power-off control of the electric buffer 211 in the nodes 21-4 and 21-5.

When, on the other hand, there is no traffic flowing through the packet transfer unit 212 (No in S2040), the power control unit 113 of the node control device 11 controls to power off the whole corresponding node 21 (S2042). The power control unit 113 determines the presence or absence of traffic on the packet transfer unit 212 for all of the nodes 21 where it is determined that there is traffic flowing through the electric buffer 211, and for the node 21 where there is no traffic flowing through the packet transfer unit 212, the power control unit 113 performs the power-off control of the whole node 21. For example, in FIG. 10, the power control unit 113 performs the power-off control of the whole node 21-6.

### Effects of Second Exemplary Embodiment

Effects of the second exemplary embodiment are described hereinbelow. In this exemplary embodiment, by implementing traffic route aggregation, the power of the whole node or the power of the electric buffer in the node can be controlled more effectively, and it is thus possible to achieve further reduction of energy consumption of the network. Specifically, because the power of the whole node and the power of the electric buffer in the node are controlled according to a result of traffic aggregation, it is possible to further reduce the energy consumption of the network.

### Third Exemplary Embodiment

A third exemplary embodiment is described hereinafter with reference to the drawings. In the third exemplary embodiment, energy consumption is further reduced by integration of server functions in addition to aggregation of traffic routes.

### Overview of Third Exemplary Embodiment

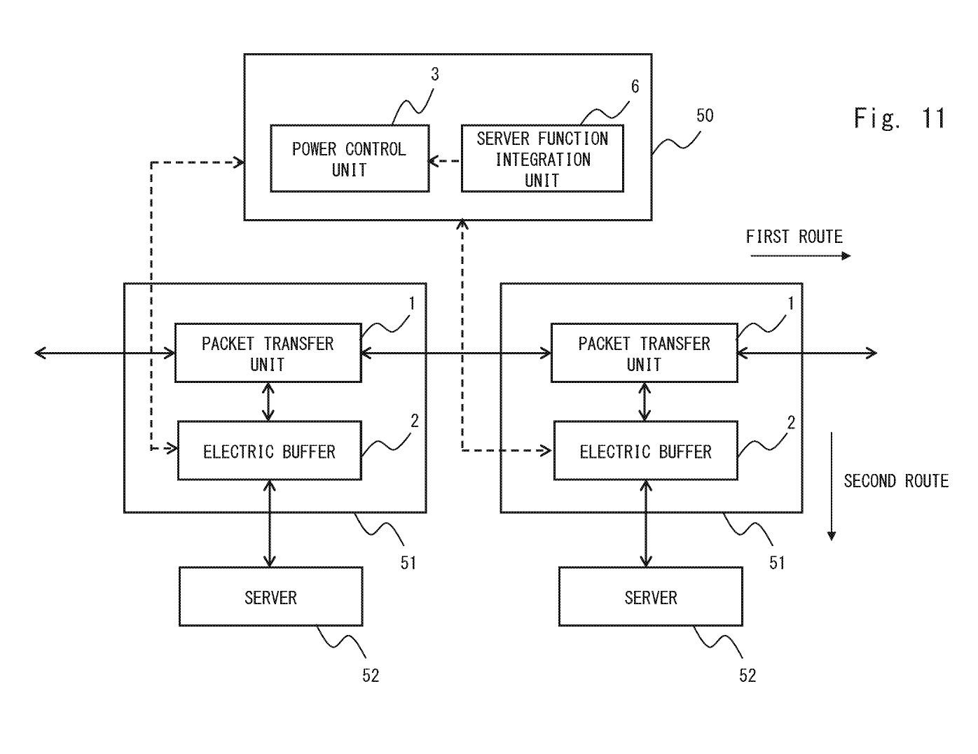

The overview of the characteristics of the third exemplary embodiment is described first. FIG. 11 shows one example of main elements of a network system according to this exemplary embodiment.

As shown in FIG. 11, the network system according to this exemplary embodiment includes a plurality of nodes 51 that constitute a network and a control device 50 that controls the plurality of nodes 51. Each of the plurality of nodes 51 includes a packet transfer unit 1 and an electric buffer 2. The packet transfer unit 1 transfers a packet between a first route (a route between the nodes 51) and a second route (a route with a part different from the node 51). The electric buffer 2 electrically stores and transfers a packet between the packet transfer unit 1 and the second route.

The control device 50 includes a server function integration unit 6 and a power control unit 3. The server function integration unit 6 integrates server functions related to traffic in a plurality of servers 52 according to the operating status of the servers 5 under the plurality of nodes 51. The power control unit 3 selects and controls any one of the power of the electric buffer 2 and the power of the whole node 51 according to the route of traffic by the integrated server function.

In this manner, in this exemplary embodiment, a plurality of server functions are integrated, and the power of the electric buffer or the whole node is controlled according to traffic by the integrated server function. By integration of server functions, the electric buffer or the node whose power can be controlled increases, and it is thereby possible to achieve further reduction of energy consumption.

### Configuration of Third Exemplary Embodiment

A configuration example of the second exemplary embodiment is described hereinafter. The configuration of the network system according to this exemplary embodiment is the same as that of the first exemplary embodiment shown in FIG. 3. The network system according to this exemplary embodiment includes a plurality of nodes (which are referred to as nodes 22 in this exemplary embodiment) that constitute a network 200 and a node control device (which is referred to as a node control device 12 in this exemplary embodiment) that controls the plurality of nodes 22. Further, a connection system 41 such as a server group 30 or an external network 40 is connected to the plurality of nodes 22. Further, in this exemplary embodiment, the node control device 12 is connected to be able to communicate with each server group 30 (server 31) so as to control a plurality of server groups 30 (servers 31).

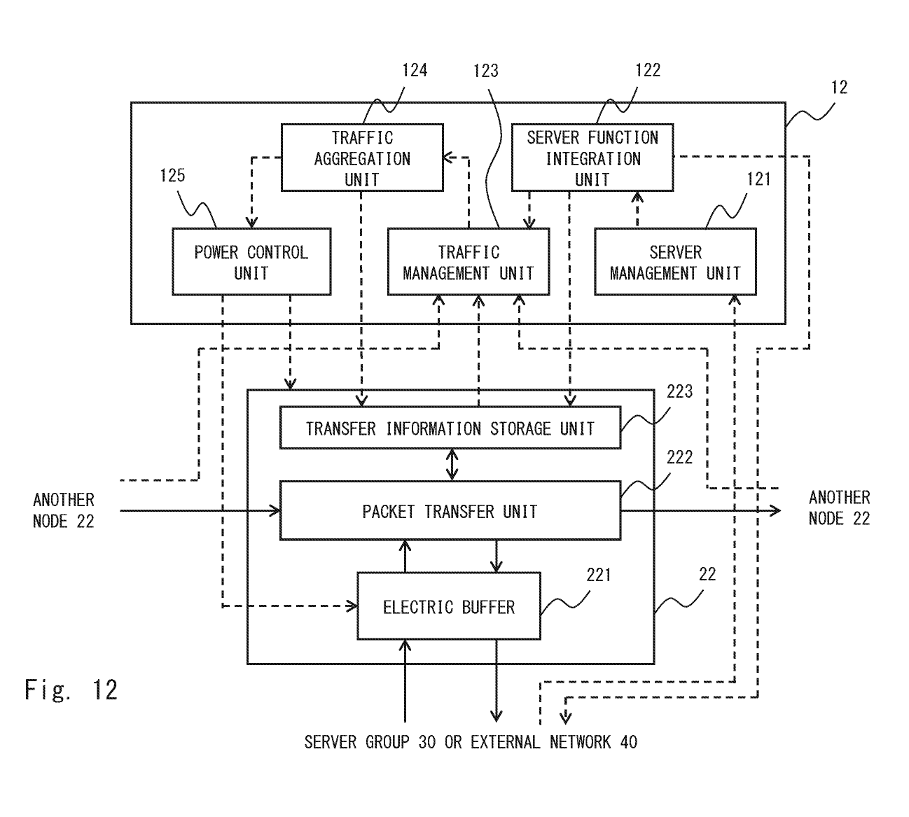

FIG. 12 shows a configuration example of the node control device 12 and the node 22 according to the third exemplary embodiment. FIG. 12 shows the node control device 12 and one node 22 included in the network system such as the one shown in FIG. 3. It is assumed that the node control device 12 is an external device of the node 22 and receives transfer information from a transfer information storage unit 223 of the plurality of nodes 22 and further receives server information from the plurality of server groups 30 (servers 31).

As shown in FIG. 12, the node 22 includes an electric buffer 221, a packet transfer unit 222 and a transfer information storage unit 223. The node 22 according to this exemplary embodiment has the same configuration as the node 20 according to the first exemplary embodiment, and it is an optical transmission device such as an optical packet router, for example.

Specifically, the transfer information storage unit 223 stores transfer information (transfer destination information, transfer table) of packets and it is referred to from the packet transfer unit 222. Further, the transfer information storage unit 223 transmits the transfer information stored in the transfer information storage unit 223 to the node control device 12.

The packet transfer unit 222 receives a packet from another node 22, determines the transmission destination corresponding to the destination information or the like of the packet based on the transfer information in the transfer information storage unit 223, and transmits the packet to the determined destination. For example, when the transmission destination is the network 200 composed of the nodes 22, the packet transfer unit 222 transmits the packet to another node 22, and when the transmission destination is other than that, the packet transfer unit 222 transmits the packet to the server group 30 or the external network 40 through the electric buffer 221.

The electric buffer 221 transmits the data (packet) that is input from another node 22 through the packet transfer unit 222 to the server group 30 or the external network 40 under the node 22. Further, the electric buffer 221 transmits the data (packet) that is input from the server group 30 or the external network 40 to another node 22 through the packet transfer unit 222.

The node control device 12 according to this exemplary embodiment includes a server management unit and a server function integration unit in addition to the elements of the node control device 11 according to the second exemplary embodiment. Specifically, as shown in FIG. 12, the node control device 12 includes a server management unit 121, a server function integration unit 122, a traffic management unit 123, a traffic aggregation unit 124, and a power control unit 125.

The server management unit 121 grasps (detects) the operating status of the server group 30 under each node 22 and transmits the grasped operating status (server operating status) to the server function integration unit 122. The server function integration unit 122 performs server function integration based on the server operating status received from the server management unit 121 and moves (integrates) the server functions. Further, the server function integration unit 122 performs traffic route setting based on a result of server function integration and notifies a result of route setting (route setting information) to the traffic management unit 123.

The traffic management unit 123 receives the route setting information from the server function integration unit 122 and further receives the transfer information in the transfer information storage unit 223 from each node 22, and grasps (detects) the traffic status in the network 200 based on the received route setting information and transfer information. Traffic information that indicates the traffic status grasped by the traffic management unit 123 is received by the traffic aggregation unit 124.

The traffic aggregation unit 124 performs aggregation of traffic based on the traffic information received from the traffic management unit 123. Further, the traffic aggregation unit 124 transmits traffic aggregation information (route aggregation information) indicating a result of traffic aggregation to the power control unit 125. The power control unit 125 performs the power-off control of the electric buffer 221 in the node 22 or the power-off control of the whole node 22 based on the traffic aggregation information received from the traffic aggregation unit 124.

### Operation of Third Exemplary Embodiment

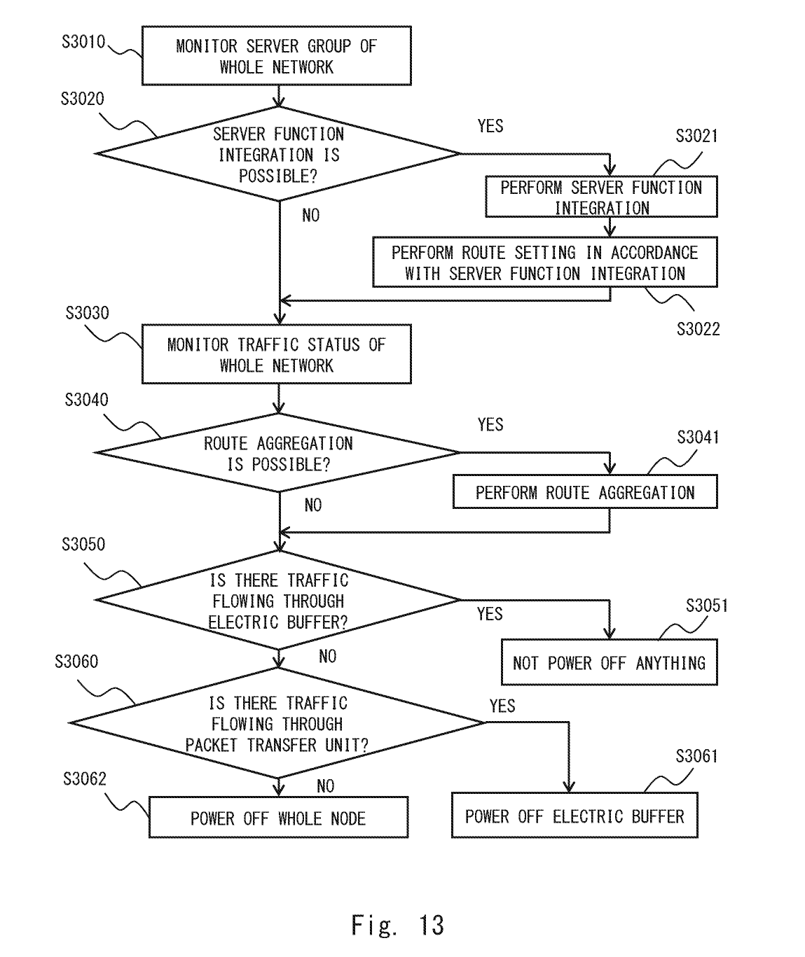

An operation example of the third exemplary embodiment is described hereinafter. FIG. 13 is a flowchart showing an operation of the node control device 12 according to the third exemplary embodiment.

First, the traffic management unit 121 of the node control device 12 monitors the server group 30 of the whole network 200 (S3010). The traffic management unit 121 collects (receives) the operating status of each server group (server 31) and transmits the collected operating status (server operating status) to the server function integration unit 122.

Next, the server function integration unit 122 of the node control device 12 checks whether integration of server functions is possible or not (S3020). The server function integration unit 122 specifies server functions (applications) that are executed by the server groups 30 (servers 31) based on the server operating status received from the server management unit 121 and determines whether the specified server functions can be integrated. For example, the server function integration unit 122 determines whether server functions can be integrated between different server groups (servers 31). Further, the server function integration unit 122 determines whether server functions can be integrated so as to eliminate the traffic of a given node 22. The server function integration unit 122 may determine whether server functions can be integrated based on the performance or the like that can be implemented by the server 30 (server 31).

When integration of server functions is possible (Yes in S3020), the server function integration unit 122 of the node control device 12 performs integration of server functions (S3021). The server function integration unit 122 moves the server functions of a target server group 30 (server 31) and integrates the server functions in the server group 30 (server 31) to which the functions are moved. The server function integration unit 122 moves the server functions between different server groups 30 (servers 31) and integrates the server functions. Further, the server function integration unit 122 integrates the server functions so as to eliminate traffic on a given node 22. As a result, it becomes possible to power off the whole node 22 with no traffic.

After server function integration (S3021), the server function integration unit 122 of the node control device 12 performs route setting of traffic according to the server function integration (S3022). In this case, the server function integration unit 122 updates the transfer information of the transfer information storage unit 223 in each node 22 so that a route between integrated server functions is formed, and notifies route setting information indicating a result of route setting information to the traffic management unit 123.

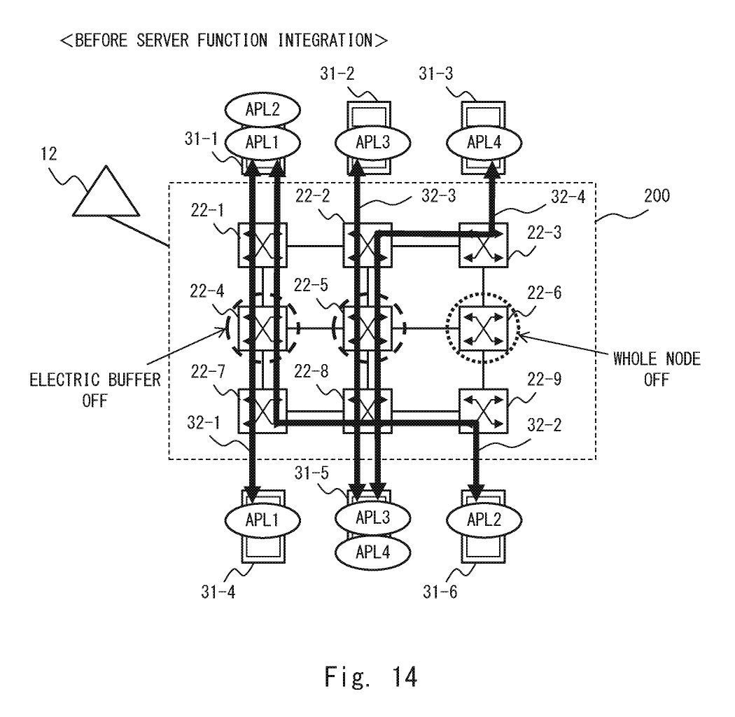

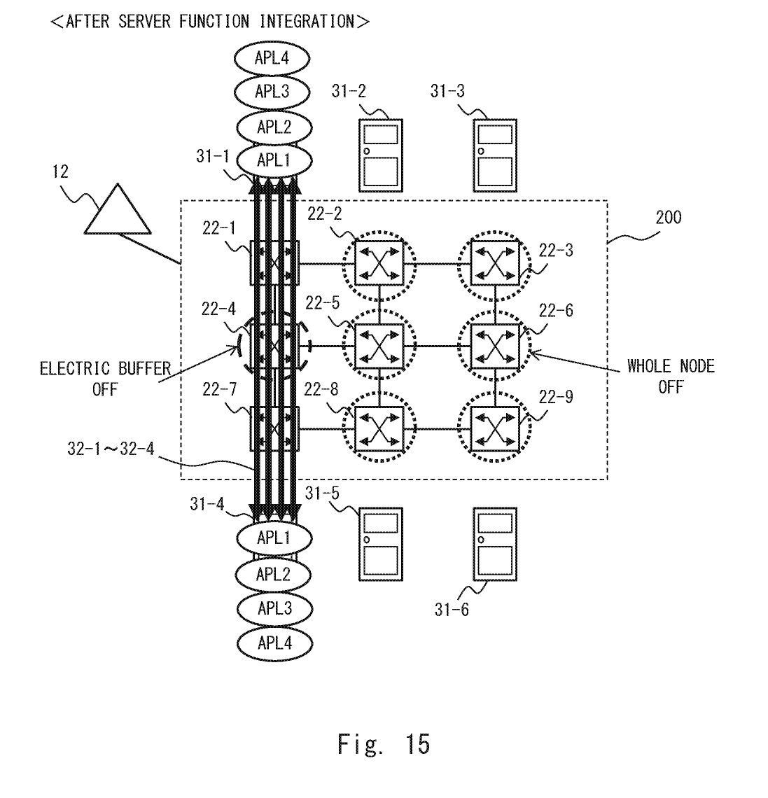

FIGS. 14 and 15 show an example of server function integration performed in S3021 and S3022. FIGS. 14 and 15 show the case where packets are transmitted between applications (server functions) of the servers 31 through the network 200 that includes nodes 22-1 to 22-9. FIG. 14 shows the state before integration of server functions, and FIG. 15 shows the state after integration of server functions. In FIGS. 14 and 15, servers 31-1 to 31-3 are respectively connected to the nodes 22-1 to 22-3, and servers 31-4 to 31-6 are respectively connected to the nodes 22-7 to 22-9.

In the state before integration of server functions in FIG. 14, the configuration is the same as that in FIG. 10. Specifically, an application APL1 of the server 31-1 and an application APL1 of the server 31-4 transmit and receive a packet through a route 32-1, an application APL2 of the server 31-1 and an application APL2 of the server 31-6 transmit and receive a packet through a route 32-2, an application APL3 of the server 31-2 and an application APL3 of the server 31-5 transmit and receive a packet through a route 32-3, and an application APL4 of the server 31-3 and an application APL4 of the server 31-5 transmit and receive a packet through a route 32-4. In FIG. 14, like in FIG. 10, the power-off control of the whole node can be performed on the node 22-6, and the power-off control of the electric buffer 221 can be performed on the nodes 22-4 and 22-5.

The server function integration unit 122 integrates the configuration of the server functions (applications) as shown in FIG. 14 in the manner as shown in FIG. 15. To be specific, as shown in FIG. 15, the applications APL1 to APL4 are integrated in the servers 31-1 and 31-4. In response to the integration of the applications APL1 to APL4, the server function integration unit 122 switches the routes 32-1 to 32-4 of the applications APL1 to APL4 to go through the nodes 22-1, 22-4 and 22-7. Specifically, the server function integration unit 122 integrates the server functions so as to eliminate traffic of the nodes 22-2, 22-3, 22-5, 22-8 and 22-9.

As shown in FIG. 15, by integrating the server functions so as to implement every application between the same servers and setting a route, traffic that goes through the nodes 22-2, 22-3, 22-5, 22-8 and 22-9 can be eliminated, and it becomes possible to control to power off the whole node on the five nodes 22 (22-2, 22-3, 22-5, 22-8 and 22-9). Specifically, in FIG. 15, the power-off control of the whole node is possible on the nodes 22-2, 22-3, 22-5, 22-6, 22-8 and 22-9, and the power-off control of the electric buffer 221 is possible on the node 22-4.

In FIG. 13, after route setting in response to server function integration (S3022) or when server function integration cannot be performed (No in S3020), the traffic management unit 123 of the node control device 12 monitors the traffic status of the whole network (S3030). The traffic management unit 123 receives the route aggregation information from the server function integration unit 122 and further receives the transfer information of the transfer information storage unit 223 from each node 22, and grasps the traffic status of the whole network 200 by the received route setting information and transfer information. The traffic management unit 123 transmits the traffic information (transfer information) indicting the grasped traffic status to the traffic aggregation unit 124.

Hereinafter, the processing of S3040 to S3062 is the same as the processing of S2020 to S2042 according to the second exemplary embodiment shown in FIG. 8.

Specifically, after S3030, the traffic aggregation unit 124 of the node control device 12 checks whether traffic route aggregation is possible or not from the traffic status of the whole network 200 (S3040).

When traffic route aggregation is possible (Yes in S3040), the traffic aggregation unit 124 of the node control device 12 performs traffic route aggregation (S3041). In this case, the traffic aggregation unit 124 updates the transfer information of the transfer information storage unit 223 in each node 22 so that the aggregate route is formed, and transmits route aggregation information (updated transfer information after route aggregation) indicating the aggregate route to the power control unit 125.

After traffic route aggregation (S3041) or when traffic route aggregation cannot be performed (No in S3040), the power control unit 125 of the node control device 12 checks whether there is traffic flowing through the electric buffer 221 of each node 22 (S3050). The checking of traffic in S3050 is done based on whether the transfer information addressed to the server group 30 or the external network 40 from each node 22 is contained in the transfer information (route aggregation information) received from the traffic aggregation unit 124. Note that, after server function integration, power control may be performed without performing traffic route aggregation. For example, the traffic management unit 123 may acquire the transfer information of the whole network (S3030), and the power control unit 125 may perform the power-off control of the electric buffer 221 or the whole node 22 based on the transfer information (S3050 to S3062).

When there is traffic flowing through the electric buffer 221 (Yes in S3050), the power control unit 125 of the node control device 12 does not perform the power-off control related to the node on the corresponding node 22 (S3051). The power control unit 125 determines the presence or absence of traffic of the electric buffer 221 for all nodes 22, and for the node 22 where there is traffic flowing through the electric buffer 221, the power control unit 125 does not perform the power-off control of the electric buffer 221 and the power-off control of the whole node 22.

When, on the other hand, there is no traffic flowing through the electric buffer 221 (No in S3050), the power control unit 125 of the node control device 12 checks whether there is traffic flowing through the packet transfer unit 222 of each node 22 (S3060). The checking of traffic in S3060 is done based on whether the transfer information of the node 22 is contained in the transfer information received from the traffic aggregation unit 124, that is, whether the transfer information is stored in the transfer information storage unit 223 of the node 22.

When there is traffic flowing through the packet transfer unit 222 (Yes in S3060), the power control unit 125 of the node control device 12 controls to power off the electric buffer 221 in the corresponding node 22 (S3061). The power control unit 125 determines the presence or absence of traffic on the packet transfer unit 222 for all of the nodes 22 where it is determined that there is traffic flowing through the electric buffer 221, and for the node 22 where there is traffic flowing through the packet transfer unit 222, the power control unit 125 performs the power-off control of the electric buffer 221. For example, in FIG. 15, the power control unit 125 performs the power-off control of the electric buffer 221 on the node 22-4.

When, on the other hand, there is no traffic flowing through the packet transfer unit 222 (No in S3060), the power control unit 125 of the node control device 12 controls to power off the whole node 22 (S3062). The power control unit 125 determines the presence or absence of traffic on the packet transfer unit 222 for all of the nodes 22 where it is determined that there is traffic flowing through the electric buffer 221, and for the node 22 where there is no traffic flowing through the packet transfer unit 222, the power control unit 125 performs the power-off control of the whole node 22. For example, in FIG. 15, the power control unit 125 performs the power-off control of the whole node 22 on the nodes 22-2, 22-3, 22-5, 22-6, 22-8 and 22-9.

### Effects of Third Exemplary Embodiment

Effects of the third exemplary embodiment are described hereinbelow. In this exemplary embodiment, by implementing server function integration in addition to traffic route aggregation, the power of the whole node or the power of the electric buffer in the node can be controlled more effectively, and it is thus possible to achieve further reduction of energy consumption of the network. Specifically, because the power of the whole node and the power of the electric buffer in the node are controlled according to a result of server function integration, it is possible to further reduce the energy consumption of the network.

It should be noted that the present invention is not limited to the above-described exemplary embodiment and may be varied in many ways within the scope of the present invention.

Each element in the above-described exemplary embodiments may be formed by hardware or software or both of them, and may be formed by one hardware or software or a plurality of hardware or software. Each function (each processing) of the node or the node control device may be implemented by a computer including CPU, memory and the like. For example, a packet transfer program or a control program for performing a packet transfer method (packet transfer process) or a control method (control process) according to the exemplary embodiments may be stored in a storage device, and each function may be implemented by executing the packet transfer program or the control program stored in the storage device on the CPU.

The program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

The whole or part of the embodiments disclosed above can be described as, but not limited to, the following supplementary notes.

### Supplementary Note 1

A node control system comprising:
a traffic management means for grasping a status of traffic transmitted in a node; and
a power control means for controlling to power off an electric buffer in the node when there is no traffic to be input and output to a device under the node or to outside of a network composed of the node in accordance with a transmission status of traffic grasped by the traffic management means.

### Supplementary Note 2

The node control system according to Supplementary note 1, wherein the power control means controls to power off the node when there is no traffic to be input and output to a device under the node or to outside of the node and when no traffic is input and output with another node connected to the node.

### Supplementary Note 3

A node control device comprising:
a traffic management function for grasping a status of traffic transmitted in a node; and
a power control function for controlling to power off an electric buffer in the node when there is no traffic to be input and output to a device under the node or to outside of a network composed of the node in accordance with a transmission status of traffic grasped by the traffic management means.

### Supplementary Note 4

The node control device according to Supplementary note 3, wherein the power control function controls to power off the node when there is no traffic to be input and output to a device under the node or to outside of the node and when no traffic is input and output with another node connected to the node.

### Supplementary Note 5

A node control method comprising:
a traffic management step of grasping a status of traffic transmitted in a node; and
a power control step of controlling to power off an electric buffer in the node when there is no traffic to be input and output to a device under the node or to outside of a network composed of the node in accordance with a transmission status of traffic grasped by the traffic management means.

### Supplementary Note 6

The node control method according to Supplementary note 5, wherein the power control step controls to power off the node when there is no traffic to be input and output to a device under the node or to outside of the node and when no traffic is input and output with another node connected to the node.

### Supplementary Note 7

A control program for node control causing a computer to perform:
a traffic management processing of grasping a status of traffic transmitted in a node; and
a power control processing of controlling to power off an electric buffer in the node when there is no traffic to be input and output to a device under the node or to outside of a network composed of the node in accordance with a transmission status of traffic grasped by the traffic management means.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2013-150611, filed on Jul. 19, 2013, the disclosure of which is incorporated herein in its entirety by reference.

### REFERENCE SIGNS LIST

1 PACKET TRANSFER UNIT

2 ELECTRIC BUFFER

3 POWER CONTROL UNIT

4 TRAFFIC DETECTION UNIT

5 TRAFFIC AGGREGATION UNIT

6 SERVER FUNCTION INTEGRATION UNIT

10, 11, 12 NODE CONTROL DEVICE

20, 21, 22 NODE

30 SERVER GROUP

31 SERVER

40 EXTERNAL NETWORK

41 CONNECTION SYSTEM

50 CONTROL DEVICE

51 NODE

52 SERVER

101, 111, 123 TRAFFIC MANAGEMENT UNIT

102, 113, 125 POWER CONTROL UNIT

112, 124 TRAFFIC AGGREGATION UNIT

121 SERVER MANAGEMENT UNIT

122 SERVER FUNCTION INTEGRATION UNIT

200 NETWORK

201, 211, 221 ELECTRIC BUFFER

202, 212, 222 PACKET TRANSFER UNIT

203, 213, 223 TRANSFER INFORMATION STORAGE UNIT

What is claimed is:

1. A packet transfer system comprising:
a packet transfer unit that transfers a packet between a first route and a second route;
an electric buffer for electrically storing and transferring the packet between the packet transfer units and the second route; and
a power control unit that controls power of the electric buffer in accordance with traffic flowing through the electric buffer.

2. The packet transfer system according to claim 1, wherein
the packet transfer unit transmits and receives an optical signal corresponding to the packet, and
the electric buffer stores an electric signal corresponding to the packet.

3. The packet transfer system according to claim 1, wherein the power control units powers off the electric buffer when no traffic flows through the electric buffer.

4. The packet transfer system according to claim 3, wherein the power control unit powers off the electric buffer when no traffic flows through the electric buffer and when traffic flows through the packet transfer unit.

5. The packet transfer system according to claim 3, wherein
the packet transfer unit and the electric buffer are included in a node that constitutes a network, and
the power control unit powers off the whole node when no traffic flows through the electric buffer and when no traffic flows through the packet transfer unit.

6. The packet transfer system according to claim 1, wherein
the packet transfer unit and the electric buffer are included in a node that constitutes a network,
the first route is a route between nodes in the network, and
the second route is a route between the node and a system connected under the node.

7. The packet transfer system according to claim 1, further comprising:
a transfer information storage unit that stores transfer information for the packet transfer unit to transfer the packet, wherein
the power control unit controls power of the electric buffer based on the stored transfer information.

8. A control device comprising:
a traffic detection unit that detects traffic flowing through an electric buffer included in a node constituting a network, the electric buffer electrically storing a packet transferred by the node; and
a power control unit that controls power of the electric buffer in accordance with the detected traffic.

9. A control method comprising:
detecting traffic flowing through an electric buffer included in a node constituting a network, the electric buffer electrically storing a packet transferred by the node; and
controlling power of the electric buffer in accordance with the detected traffic.

10. A non-transitory computer-readable medium storing a control program causing a computer to perform a control process comprising:
detecting traffic flowing through an electric buffer included in a node constituting a network, the electric buffer electrically storing a packet transferred by the node; and
controlling power of the electric buffer in accordance with the detected traffic.

11. A packet transfer system comprising:
a packet transfer means for transferring a packet between a first route and a second route;
an electric buffer for electrically storing and transferring the packet between the packet transfer means and the second route; and
a power control means for controlling power of the electric buffer in accordance with traffic flowing through the electric buffer.

12. A control device comprising:
a traffic detection means for detecting traffic flowing through an electric buffer included in a node constituting a network, the electric buffer electrically storing a packet transferred by the node; and
a power control means for controlling power of the electric buffer in accordance with the detected traffic.
